(19) United States
(12) Patent Application Publication
(10) Pub. No.: US 2011/0114589 A1
(43) Pub. Date: May 19, 2011

(54) SUPPLEMENTAL FEEDING BOTTLE DEVICE AND METHOD OF PREPARATION AND USE

(76) Inventors: Levy Bathan, San Bernardino, CA (US); Merlinda Bathan, San Bernardino, CA (US)

(21) Appl. No.: 12/907,005

(22) Filed: Oct. 18, 2010

Related U.S. Application Data
(60) Provisional application No. 61/253,518, filed on Oct. 21, 2009.

(51) Int. Cl. B65D 1/04; B65D 23/00; A61J 9/00

(52) U.S. Cl. 215/6; 215/365; 215/11.1

(57) ABSTRACT

The present invention is a supplemental feeding bottle device, used in combination with a feeding bottle for a baby. The supplemental feeding bottle device has a first piece with a top outside thread, a bottom outside thread, a rotatable o-ring, a flat round surface at the bottom and a gap for baby food to be held and dispersed into the feeding bottle. The gap is formed between the o-ring and the flat round surface and a second section with a top inside thread and bottom inside thread, an inside wall and lumps on the inside wall. The first section can be rotated counter-clockwise so the o-ring is locked in place between the lumps to prevent the separation of the first and bottom sections of the supplemental feeding bottle device.

This application claims priority to U.S. Provisional Application 61/253,518 filed on Oct. 21, 2009, the entire disclosure of which is incorporated by reference.

### TECHNICAL FIELD & BACKGROUND

Preparing a child's bottle can be a tedious task. The feeding bottle needs to be opened, as well as the formula container. The formula then needs to be measured and poured into the bottle. Both the formula container lid and the feeding bottle lid need to be replaced before the feeding bottle is shaken. This preparation is often not possible when in a car, at a restaurant, or on the go. It is both time-consuming and inconvenient and a more efficient and convenient method of preparation is needed.

The invention is a supplemental feeding bottle device that can be attached to a child's feeding bottle. It is designed for parents and caregivers and provides a simple and efficient method of preparing a bottle for feeding and use. It eliminates the hassle of pouring formula into a bottle, which is often inconvenient when a provider is on the go. This product provides convenience, enabling an individual to easily mix a child's bottle quickly and with no mess. The invention also includes a method of bottle preparation and a method of use.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a front environmental perspective view of a supplemental feeding bottle device, in accordance with one embodiment of the present invention.

FIG. 1B illustrates a front perspective view of a top portion of a supplemental feeding bottle device, in accordance with one embodiment of the present invention.

FIG. 1C illustrates a front perspective view of a second section of a supplemental feeding bottle device, in accordance with one embodiment of the present invention.

FIGS. 2A and 2B illustrate a flow chart of a method of feeding bottle preparation for a baby, in accordance with one embodiment of the present invention.

FIGS. 3A and 3B illustrate a flow chart of a method of using a supplemental feeding bottle device to feed a baby, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

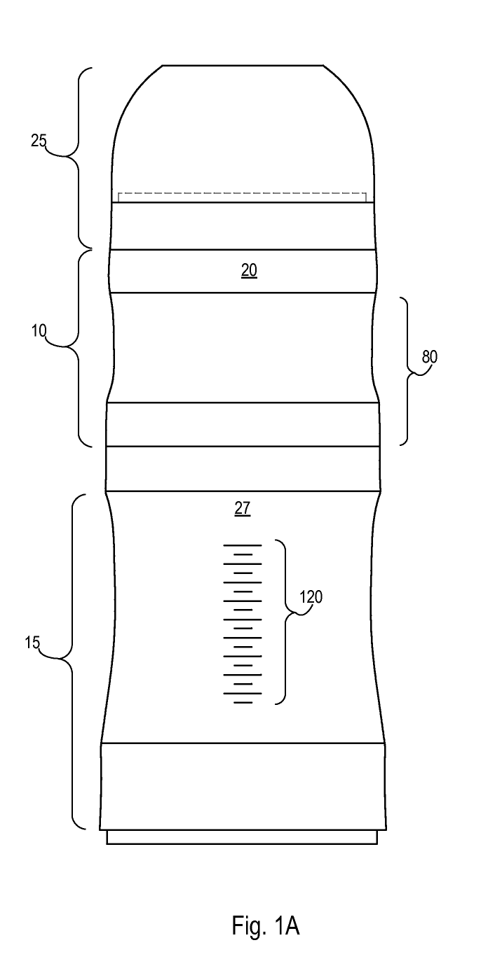

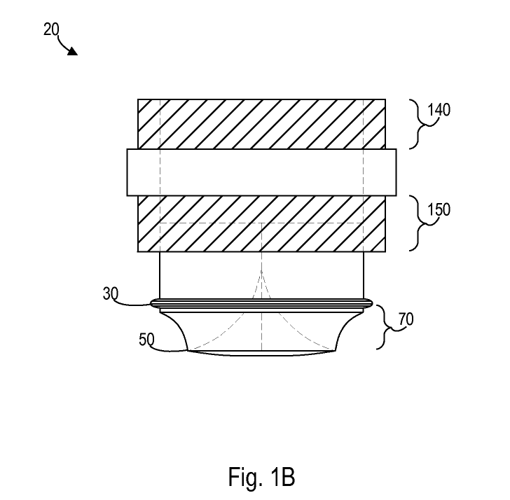

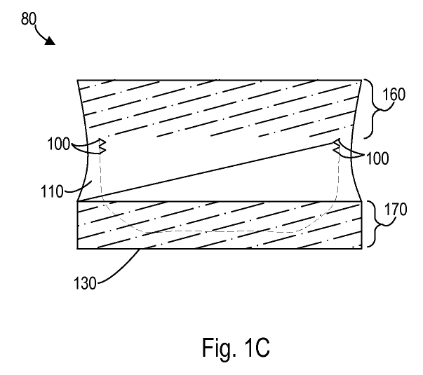

FIG. 1A illustrates a front environmental perspective view of a supplemental feeding bottle device 10, in accordance with one embodiment of the present invention. FIG. 1B illustrates a front perspective view of a top portion 20 of a supplemental feeding bottle device 10, in accordance with one embodiment of the present invention. FIG. 1C illustrates a front perspective view of a second section 80 of a supplemental feeding bottle device 10, in accordance with one embodiment of the present invention. The supplemental feeding bottle device 10 provides a simple method of bottle preparation. The supplemental feeding bottle device 10 can be connected between a feeding bottle 15 and its nipple and gasket 25 to make the process easier and faster. The supplemental feeding bottle device 10 is made of two separate pieces. The first piece, which is the first section 20, holds the powdered milk formula or any other feeding bottle food 27 that can be consumed by a baby or child that is well known in the art. It has an O-ring 30 at the lower portion of the first section 20 of the supplemental feeding bottle device 10 and a flat round surface 50 at the bottom of the first section 20 of the supplemental feeding bottle device 10. Between the O-ring 30 and the flat surface 50 is a gap 70 where feeding bottle food 27 comes out.

The second section 80 of the supplemental feeding bottle device 10 has a top inside thread 160 and a bottom inside thread 170. The top inside thread 160 of the second piece 80 threads onto the bottom outside thread 150 of the first piece 20, while the bottom inside thread 170 of the second piece 80 threads onto the feeding bottle 15. The second section 80 has an opening 130 and two humps 100 on the inside wall 110. To prepare the feeding bottle food 27, the first section 20 is turned counter-clockwise and the flat round surface 50 will elevate from the opening 130 of the second piece 80 dispensing feeding bottle food 27 into the feeding bottle 15. The first section 20 can then be turned clockwise to close the opening 130 of the second section 80 and then shake the feeding bottle 15 until the feeding bottle food 27 is completely dissolved. The first section 20 can then be turned counter-clockwise until the O-ring 30 is locked between the two humps 100 to prevent the child from separating the first section 20 and the bottom section 80 of the supplemental feeding bottle device 10. Then the feeding bottle 15 is ready for the baby or child being fed.

The supplemental feeding bottle device 10 may measure approximately 2¾ in diameter and 2⅞″ in height. The supplemental feeding bottle device 10 may come with the accompanying feeding bottle 15 or may be made to fit existing bottles. It may be green with white lettering or indicia 120 although other colors and indicia well known in the art can also be used. The exact specifications and dimensions may vary that are well known in the art as well.

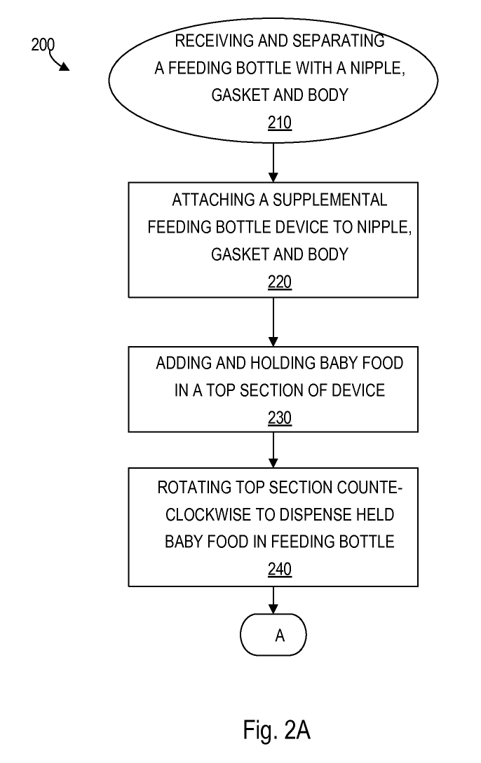

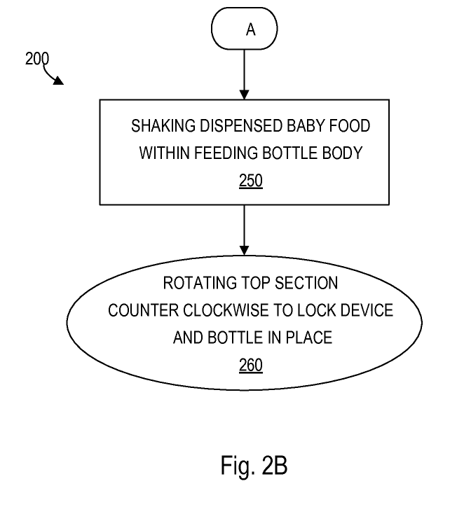

FIGS. 2A and 2B illustrate a flow chart of a method of feeding bottle preparation for a baby 200, in accordance with one embodiment of the present invention. The steps of the method of feeding bottle preparation for a baby 200 include receiving and separating a feeding bottle with a nipple and gasket and a body 210, attaching a supplemental feeding bottle device between the body and the nipple and gasket 220, adding and holding baby food into a first section of the supplemental feeding bottle device 230, rotating the first section counter-clockwise to dispense the held baby food into the feeding bottle body 240, shaking the dispensed baby food within the feeding bottle body for consumption preparation 250 and rotating the first section counter-clockwise to lock the two pieces of the supplemental feeding bottle device together into place for use 260.

The baby food used in the method of feeding bottle preparation for a baby 200 is powdered milk formula or any other baby food that is well known in the art. The method of feeding bottle preparation for a baby 200 includes a top outside thread of the first section threading onto the nipple and gasket and a bottom outside thread of the first section threading onto the top inside thread of the second piece of the supplemental feeding bottle device 10. The method of feeding bottle preparation for a baby 200 also includes the first section being locked into place with a plurality of humps disposed on inside walls of the second section of the supplemental feeding bottle. The method of feeding bottle preparation for a baby 200 also includes the baby being fed when the dispensed baby food is shaken and dissolved and the two pieces of the supplemental feeding bottle device are locked into place.

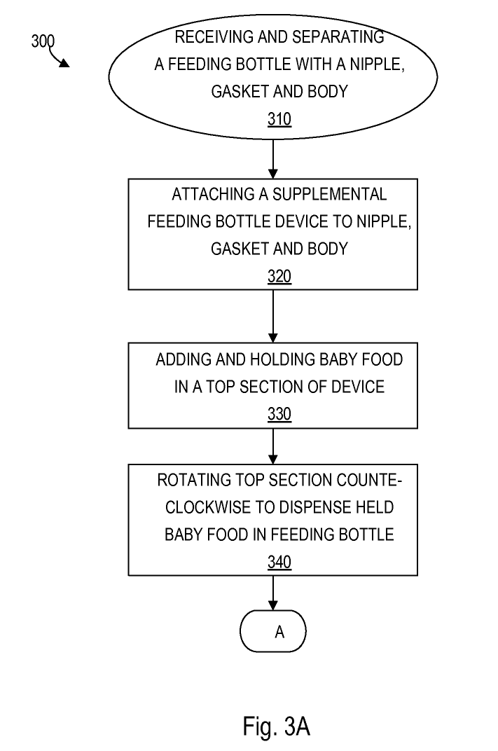

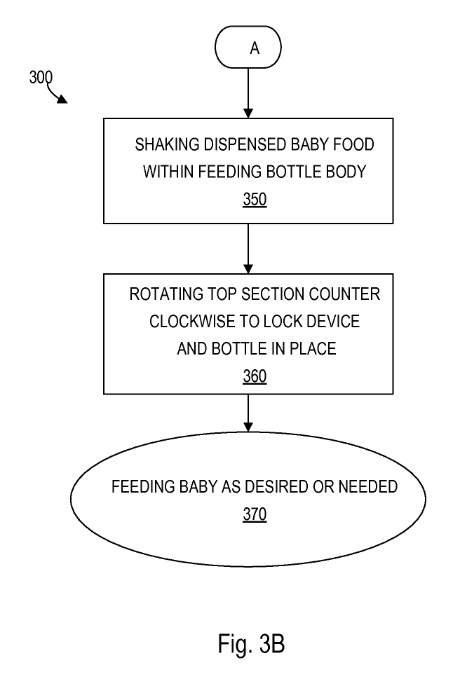

FIGS. 3A and 3B illustrate a flow chart of a method of using a supplemental feeding bottle device to feed a baby 300, in accordance with one embodiment of the present invention. The steps of the method of using a supplemental feeding bottle device to feed a baby 300 include receiving the supplemental feeding bottle device and a feeding bottle with a nipple and gasket and a body 310, attaching a supplemental feeding bottle device between the body and the nipple and gasket 320, adding and holding baby food into a first section of the supplemental feeding bottle device 330, rotating the first section counter-clockwise to dispense the held baby food into the feeding bottle body 340, shaking the dispensed baby food within the feeding bottle body for consumption preparation 350, rotating the first section counter-clockwise to lock the two pieces of the supplemental feeding bottle together into place for use 360 and feeding the baby as desired or needed with the supplemental feeding bottle device and the feeding bottle 370.

The baby food used in the method of using a supplemental feeding bottle device to feed a baby 300 is powdered milk formula or any other baby food that is well known in the art. The method of using a supplemental feeding bottle device to feed a baby 300 includes a top outside thread of the first piece threading onto the nipple and gasket and a bottom outside thread of the threading onto the top inside thread of the second piece while the bottom inside thread of the second piece threads onto the feeding bottle. The method of using a supplemental feeding bottle device to feed a baby 300 also includes the first section being locked into place with a plurality of humps disposed on inside walls of the second piece of the supplemental feeding bottle device. The method of using a supplemental feeding bottle device to feed a baby 300 also includes the baby being fed when the dispensed baby food is shaken and dissolved and the two pieces of the supplemental feeding bottle device are locked into place.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A supplemental feeding bottle device, used in combination with a feeding bottle for a baby, comprising:
a first section with a top outside thread, a bottom outside thread, a rotatable o-ring, a flat round surface at the bottom and a gap for baby food to be held and dispersed into said feeding bottle, said gap is formed between said o-ring and said flat round surface; and
a second section with a top inside thread and bottom inside thread, an inside wall and lumps on said inside wall the first section can be rotated counter-clockwise so said o-ring is locked in place between said lumps to prevent the separation of the two pieces of the said supplemental feeding bottle device.

2. The device according to claim 1, wherein said top of first section threads onto a feeding bottle nipple and gasket of said feeding bottle.

3. The device according to claim 1, wherein said baby food is powdered milk formula.

4. The device according to claim 1, wherein said first section can be rotated counter-clockwise to dispense said held baby food into said feeding bottle.

5. The device according to claim 4, wherein said dispensed baby food can be shaken for consumption preparation.

6. The device according to claim 5, wherein said baby can be fed when said dispensed baby food is shaken and said supplemental feeding bottle device is locked into place.

7. The device according to claim 1, wherein said body has measurement indicia.

8. A method of feeding bottle preparation for a baby, comprising:
receiving a feeding bottle with a nipple and gasket and a body and separating said nipple and gasket and said body;
attaching a supplemental feeding bottle device between said body and said nipple and gasket;
adding and holding baby food into a first section of said supplemental feeding bottle device;
rotating said first section counter-clockwise to dispense said held baby food into said feeding bottle body;
shaking said dispensed baby food within said feeding bottle body for consumption preparation; and
rotating said first section counter-clockwise to lock said two pieces of the supplemental feeding bottle device together into place for use.

9. The method according to claim 8, wherein said baby food is powdered milk formula.

10. The method according to claim 8, wherein a top outside thread of said first piece threads onto said nipple and gasket and a bottom outside thread of said first piece threads onto said top inside thread of the second piece while the bottom inside thread of the second piece threads onto the feeding bottle.

11. The method according to claim 8, wherein said first section is locked into place with a plurality of humps disposed on inside walls of said second piece of the supplemental feeding bottle device.

12. The method according to claim 8, wherein said baby can be fed when said dispensed baby food is shaken and said supplemental feeding bottle device is locked into place.

13. The method according to claim 8, wherein said body has measurement indicia.

14. A method of using a supplemental feeding bottle device to feed a baby, comprising:
receiving said supplemental feeding bottle device and a feeding bottle with a nipple and gasket and a body;
attaching a supplemental feeding bottle device between said body and said nipple and gasket;
adding and holding baby food into a first section of said supplemental feeding bottle device;
rotating counter-clockwise said first section to dispense said held baby food into said feeding bottle body;
shaking said dispensed baby food within said feeding bottle body for consumption preparation;
rotating said first section counter-clockwise to lock said two pieces of the supplemental feeding bottle device together into place for use; and
feeding said baby as desired or needed with said supplemental feeding bottle device and said feeding bottle.

15. The method according to claim 14, wherein said baby food is powdered milk formula.

16. The method according to claim 14, wherein a top outside thread of said first piece threads onto said nipple and gasket and a bottom outside thread of said first piece threads onto said top inside thread of the second piece while the bottom inside thread of the second threads onto the feeding bottle.

17. The method according to claim 14, wherein said first section is locked into place with a plurality of humps disposed on inside wall of said bottom section of the supplemental feeding bottle device.

18. The method according to claim 14, wherein said baby can be fed when said dispensed baby food is shaken and said supplemental feeding bottle device is locked into place.

19. The method according to claim 14, wherein said body has measurement indicia.
